(19) United States
(12) Patent Application Publication
(10) Pub. No.: US 2022/0188552 A1
(43) Pub. Date: Jun. 16, 2022

(54) Systems, Apparatus, and Methods for Reordering Image Data

(71) Applicant: Waymo LLC, Mountain View, CA (US)

(72) Inventor: Pieter Kapsenberg, Mountain View, CA (US)

(21) Appl. No.: 17/119,108

(22) Filed: Dec. 11, 2020

(51) Int. Cl. G06K 9/00; B60W 60/00; G06K 9/62; G06F 16/22

(52) U.S. Cl. CPC G06K 9/00791; B60W 60/001; G06K 9/6202; B60W 2420/52; G06F 16/2282; B60W 2420/403; G06F 16/221

(57) ABSTRACT

Described examples relate to an apparatus for rearranging or reordering image data of a stream. The apparatus may include control circuitry coupled to a memory array. The control circuitry may be configured to receive the image data of the stream that includes a first image comprising first data elements organized in a row-wise format or a column-wise format and a second image comprising second data elements organized in a row-wise format or a column-wise format. The control circuitry may also be configured to write the first data elements to the memory array in a first order according to a first addressing sequence, read the first data elements from the memory array in a second order according to a second addressing sequence, and write the second data elements in the memory array according to the second addressing sequence.

### BACKGROUND

Autonomous vehicles may use various computing systems to aid in the transport of passengers from one location to another. Some autonomous vehicles may require some initial input or continuous input from an operator, such as a pilot, driver, or passenger. Other systems, such as autopilot systems, may be used only when the system has been engaged, which permits the operator to switch from a manual mode (where the operator may exercise a high degree of control over the movement of the vehicle) to an autonomous mode (where the vehicle essentially drives itself) to modes that lie somewhere in between.

Such vehicles are typically equipped with various types of sensors in order to detect objects in the surroundings. For example, an autonomous vehicle may include lasers, sonar, radar, cameras, and other devices which scan and record data from the surroundings of the vehicle. Sensor or image data from one or more of these devices may be used to detect the characteristics (position, shape, heading, speed, etc.) of the object.

In some applications, it may be desirable to rearrange or reorder the image data. Traditional memory architectures typically rearrange sensor data using two memory banks or buffers, whereby both of the memory banks are used alternately for reordering the sensor data. In such memory architectures, both memory banks may have the capacity to store image data, and while a first image may be written to a first memory bank, a second image may be read from a second memory bank. However, using two memory banks for reordering images may increase the amount of memory required to process image data and may also increase the cost and latency in (e.g., delay through) the memory architecture.

### SUMMARY

Systems, methods, and apparatus for reordering or rearranging image data are disclosed. In one aspect, the present application describes an apparatus for rearranging image data of a stream. The apparatus may include control circuitry coupled to a memory array. The control circuitry may be configured to receive the image data of the stream that includes a first image comprising first data elements organized in a row-wise format or a column-wise format and a second image comprising second data elements organized in a row-wise format or a column-wise format. The control circuitry may also be configured to write the first data elements to the memory array in a first order according to a first addressing sequence, read the first data elements from the memory array in a second order according to a second addressing sequence, and write the second data elements in the memory array according to the second addressing sequence.

In another aspect, the present application describes a method of rearranging image data in a stream. The method includes receiving, at a memory, the image data of the stream, the image data having first data elements of a first image and second data elements of a second image, the first data elements organized in a row-wise format or a column-wise format and the second data elements organized in a row-wise format or a column-wise format. The method also comprises writing the first data elements in memory locations of the memory in a first order using a first addressing sequence, reading the first data elements from the memory locations in a second order using a second addressing sequence, and writing the second data elements in the memory locations using the second addressing sequence.

In still another aspect, a non-transitory computer-readable medium storing instructions is disclosed that, when executed by a processor in a computing system, causes the computing system to perform operations. The operations may include receiving, at a memory, the image data of the stream, the image data having first data elements of a first image and second data elements of a second image, the first data elements organized in a row-wise format or a column-wise format and the second data elements organized in a row-wise format or a column-wise format. The operations also include writing the first data elements in memory locations of the memory in a first order using a first addressing sequence, reading the first data elements from the memory locations in a second order using a second addressing sequence, and writing the second data elements in the memory locations using the second addressing sequence.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE DRAWINGS

FIG. 1 is a functional block diagram illustrating a vehicle, according to an example implementation;

FIG. 2 is a conceptual illustration of a physical configuration of a vehicle, according to an example implementation;

FIG. 3A is a conceptual illustration of wireless communication between various computing systems related to an autonomous vehicle, according to an example implementation;

FIG. 3B is a simplified block diagram depicting components of a camera system, according to an example implementation;

FIG. 3C is a conceptual illustration of an imaging operation of an example apparatus;

FIG. 4 illustrates an image sensor of an imaging system, according to an example implementation;

FIG. 5 is a conceptual illustration of image data captured by an image sensor, according to an example implementation;

FIG. 6 a conceptual illustration of data elements of an image organized in a row-major format, according to an example implementation;

FIG. 7 a conceptual illustration of data elements of an image organized in a column-major format, according to an example implementation;

FIG. 8 is a simplified block diagram depicting components of a memory buffer, according to an example implementation;

FIG. 9 is a flow chart of a method, according to an example implementation.

FIG. 10 illustrates an image sensor of an imaging system, according to an example implementation;

FIG. 11 is a conceptual illustration of image data captured by the image sensor of FIG. 10, according to an example implementation;

FIG. 12 is a conceptual illustration of a memory array of a memory buffer, according to an example implementation;

FIG. 13 is a conceptual illustration of four consecutive images captured by the image sensor of FIG. 10, according to an example implementation; and

FIGS. 14a-14h are conceptual illustrations showing successive read and write operations performed by a memory buffer, according to an example implementation.

### DETAILED DESCRIPTION

Example systems, apparatus, and methods are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein. Additionally, in this disclosure, unless otherwise specified and/or unless the particular context clearly dictates otherwise, the terms “a” or “an” means at least one, and the term “the” means the at least one. Yet further, the term “enabled” may mean active and/or functional, not necessarily requiring an affirmative action to turn on.

Furthermore, the particular arrangements shown in the Figures should not be viewed as limiting. It should be understood that other implementations might include more or less of each element shown in a given Figure. Further, some of the illustrated elements may be combined or omitted. Yet further, an example implementation may include elements that are not illustrated in the Figures.

The present disclosure provides systems, apparatus, and methods that improve the functioning of computer systems of autonomous vehicles by reordering or rearranging image data for processing. An autonomous vehicle operating on a road or other surface may rely on identifying objects within the vicinity of the vehicle in order to determine a safe trajectory or path for the vehicle to continue traveling upon. A computing device controlling the vehicle in autonomous mode may use one or more image-capture devices, such as cameras or video recorders, for capturing images of objects within the surrounding environment of the vehicle to assist with navigation through the environment. The image-capture devices may be positioned on the vehicle to capture the various angles of objects nearby the vehicle or within the upcoming path of the vehicle. The image capture devices may be coupled to a processor configured to perform one or more image processing tasks.

During operation, the image-capture devices may capture a relatively large amount of image data for detection, recognition, tracking, classification, and other analysis of objects within the environment. For example, capturing images at a high frame rate may allow for analysis of fast moving objects by representing such objects without motion blur. Similarly, capturing high-resolution images may allow for analysis of far-away objects. Notably, in some cases, such objects might be represented in a portion of the entire image generated by an image sensor, rather than taking up the entirety of the image.

Because of the large amount of image data captured by the image-captured devices, processing the image data may be computationally and memory intensive. In order to reduce the computational and memory usage of the system, the image data may be reordered in a manner to improve the efficiency of processing the image data. To achieve this, the image data may be rearranged or reordered prior to providing the image data for image processing. For example, an image capture device (e.g., a camera) of a vehicle may capture image data associated with the environment and reorder the image data. The image capture device may then provide the reordered image data to the vehicle systems for image processing, such as compressing the image data.

In one aspect, a memory buffer or storage device may be used to reorder the image data for image processing. The memory buffer may receive a data stream comprising a sequence of two-dimensional images or image frames. Each image may include a number of data elements arranged in rows or columns. The memory buffer may serially receive the data elements of each image in an input order and may output the data elements of each image in an order different than the input order. In exemplary implementations, the memory buffer may be configured to write the data elements of an image to memory locations of the memory buffer in a first order according to a first sequence of addresses. The first sequence of addresses may be used to write the data elements of the image in a first series of memory locations in a row-major order or row-wise serial order. The memory buffer may also be configured to read the data elements of the image in a second order according to a second sequence of addresses. The second sequence of addresses may be used to read the data elements of the image from a second series of memory locations in a column-major order or column-wise serial order. As a result, the memory buffer may receive the data elements of an image in a row-major order and output the data elements in a column-major order.

Example systems, apparatus, and method within the scope of the present disclosure will now be described in greater detail. An example system may be implemented in or may take the form of a computer system of an automobile. However, an example system may also be implemented in or take the form of other systems for vehicles, such as cars, trucks, motorcycles, buses, boats, airplanes, helicopters, lawn mowers, earth movers, boats, snowmobiles, aircraft, recreational vehicles, amusement park vehicles, farm equipment, construction equipment, trams, golf carts, trains, trolleys, and robot devices. Other vehicles are possible as well.

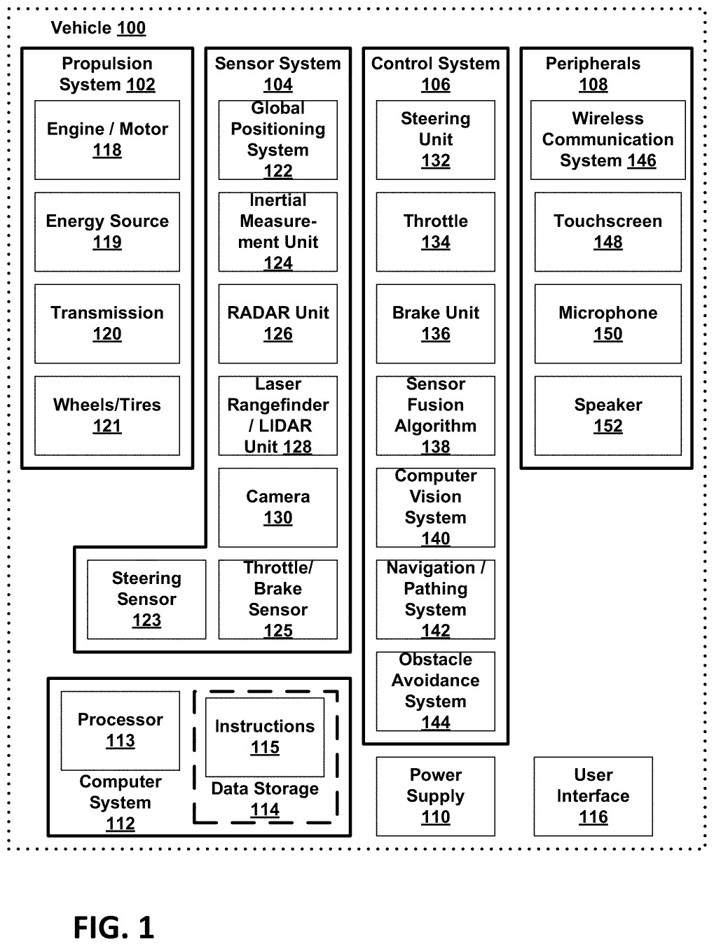

Referring now to the figures, FIG. 1 is a functional block diagram illustrating an example vehicle 100, which may be configured to operate fully or partially in an autonomous mode. More specifically, the vehicle 100 may operate in an autonomous mode without human interaction through receiving control instructions from a computing system. As part of operating in the autonomous mode, the vehicle 100 may use sensors to detect and possibly identify objects of the surrounding environment to enable safe navigation. In some implementations, the vehicle 100 may also include subsystems that enable a driver to control operations of the vehicle 100.

As shown in FIG. 1, the vehicle 100 may include various subsystems, such as a propulsion system 102, a sensor system 104, a control system 106, one or more peripherals 108, a power supply 110, a computer system 112, a data storage 114, and a user interface 116. In other examples, the vehicle 100 may include more or fewer subsystems, which can each include multiple elements. The subsystems and components of the vehicle 100 may be interconnected in various ways. In addition, functions of the vehicle 100 described herein can be divided into additional functional or physical components, or combined into fewer functional or physical components within implementations.

The propulsion system 102 may include one or more components operable to provide powered motion for the vehicle 100 and can include an engine/motor 118, an energy source 119, a transmission 120, and wheels/tires 121, among other possible components. For example, the engine/motor 118 may be configured to convert the energy source 119 into mechanical energy and can correspond to one or a combination of an internal combustion engine, an electric motor, steam engine, or Stirling engine, among other possible options. For instance, in some implementations, the propulsion system 102 may include multiple types of engines and/or motors, such as a gasoline engine and an electric motor.

The energy source 119 represents a source of energy that may, in full or in part, power one or more systems of the vehicle 100 (e.g., an engine/motor 118). For instance, the energy source 119 can correspond to gasoline, diesel, other petroleum-based fuels, propane, other compressed gas-based fuels, ethanol, solar panels, batteries, and/or other sources of electrical power. In some implementations, the energy source 119 may include a combination of fuel tanks, batteries, capacitors, and/or flywheels.

The transmission 120 may transmit mechanical power from the engine/motor 118 to the wheels/tires 121 and/or other possible systems of the vehicle 100. As such, the transmission 120 may include a gearbox, a clutch, a differential, and a drive shaft, among other possible components. A drive shaft may include axles that connect to one or more of the wheels/tires 121.

The wheels/tires 121 of the vehicle 100 may have various configurations within example implementations. For instance, the vehicle 100 may exist in a unicycle, bicycle/motorcycle, tricycle, or car/truck four-wheel format, among other possible configurations. As such, the wheels/tires 121 may connect to the vehicle 100 in various ways and can exist in different materials, such as metal and rubber.

The sensor system 104 can include various types of sensors, such as a Global Positioning System (GPS) 122, an inertial measurement unit (IMU) 124, a radar 126, a laser rangefinder/LIDAR 128, a camera 130, a steering sensor 123, and a throttle/brake sensor 125, among other possible sensors. In some implementations, the sensor system 104 may also include sensors configured to monitor internal systems of the vehicle 100 (e.g., 02 monitor, fuel gauge, engine oil temperature, brake wear).

The GPS 122 may include a transceiver operable to provide information regarding the position of vehicle 100 with respect to the Earth. The IMU 124 may have a configuration that uses one or more accelerometers and/or gyroscopes and may sense position and orientation changes of vehicle 100 based on inertial acceleration. For example, the IMU 124 may detect a pitch and yaw of the vehicle 100 while the vehicle 100 is stationary or in motion.

The radar 126 may represent one or more systems configured to use radio signals to sense objects, including the speed and heading of the objects, within the local environment of the vehicle 100. As such, the radar 126 may include antennas configured to transmit and receive radio signals. In some implementations, the radar 126 may correspond to a mountable radar system configured to obtain measurements of the surrounding environment of the vehicle 100.

The laser rangefinder/LIDAR 128 may include one or more laser sources, a laser scanner, and one or more detectors, among other system components, and may operate in a coherent mode (e.g., using heterodyne detection) or in an incoherent detection mode. The camera 130 may include one or more devices (e.g., still camera or video camera) configured to capture images of the environment of the vehicle 100.

The steering sensor 123 may sense a steering angle of the vehicle 100, which may involve measuring an angle of the steering wheel or measuring an electrical signal representative of the angle of the steering wheel. In some implementations, the steering sensor 123 may measure an angle of the wheels of the vehicle 100, such as detecting an angle of the wheels with respect to a forward axis of the vehicle 100. The steering sensor 123 may also be configured to measure a combination (or a subset) of the angle of the steering wheel, electrical signal representing the angle of the steering wheel, and the angle of the wheels of the vehicle 100.

The throttle/brake sensor 125 may detect the position of either the throttle position or brake position of the vehicle 100. For instance, the throttle/brake sensor 125 may measure the angle of both the gas pedal (throttle) and brake pedal or may measure an electrical signal that could represent, for instance, an angle of a gas pedal (throttle) and/or an angle of a brake pedal. The throttle/brake sensor 125 may also measure an angle of a throttle body of the vehicle 100, which may include part of the physical mechanism that provides modulation of the energy source 119 to the engine/motor 118 (e.g., a butterfly valve or carburetor). Additionally, the throttle/brake sensor 125 may measure a pressure of one or more brake pads on a rotor of the vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of the vehicle 100. In other implementations, the throttle/brake sensor 125 may be configured to measure a pressure applied to a pedal of the vehicle, such as a throttle or brake pedal.

The control system 106 may include components configured to assist in navigating the vehicle 100, such as a steering unit 132, a throttle 134, a brake unit 136, a sensor fusion algorithm 138, a computer vision system 140, a navigation/pathing system 142, and an obstacle avoidance system 144. More specifically, the steering unit 132 may be operable to adjust the heading of the vehicle 100, and the throttle 134 may control the operating speed of the engine/motor 118 to control the acceleration of the vehicle 100. The brake unit 136 may decelerate vehicle 100, which may involve using friction to decelerate the wheels/tires 121. In some implementations, brake unit 136 may convert kinetic energy of the wheels/tires 121 to electric current for subsequent use by a system or systems of the vehicle 100.

The sensor fusion algorithm 138 may include a Kalman filter, Bayesian network, or other algorithms that can process data from the sensor system 104. In some implementations, the sensor fusion algorithm 138 may provide assessments based on incoming sensor data, such as evaluations of individual objects and/or features, evaluations of a particular situation, and/or evaluations of potential impacts within a given situation.

The computer vision system 140 may include hardware and software operable to process and analyze images in an effort to determine objects, environmental objects (e.g., stop lights, road way boundaries, etc.), and obstacles. As such, the computer vision system 140 may use object recognition, Structure From Motion (SFM), video tracking, and other algorithms used in computer vision, for instance, to recognize objects, map an environment, track objects, estimate the speed of objects, etc.

The navigation/pathing system 142 may determine a driving path for the vehicle 100, which may involve dynamically adjusting navigation during operation. As such, the navigation/pathing system 142 may use data from the sensor fusion algorithm 138, the GPS 122, and maps, among other sources to navigate the vehicle 100. The obstacle avoidance system 144 may evaluate potential obstacles based on sensor data and cause systems of the vehicle 100 to avoid or otherwise negotiate the potential obstacles.

As shown in FIG. 1, the vehicle 100 may also include peripherals 108, such as a wireless communication system 146, a touchscreen 148, a microphone 150, and/or a speaker 152. The peripherals 108 may provide controls or other elements for a user to interact with the user interface 116. For example, the touchscreen 148 may provide information to users of the vehicle 100. The user interface 116 may also accept input from the user via the touchscreen 148. The peripherals 108 may also enable the vehicle 100 to communicate with devices, such as other vehicle devices.

The wireless communication system 146 may wirelessly communicate with one or more devices directly or via a communication network. For example, the wireless communication system 146 could use 3G cellular communication, such as CDMA, EVDO, GSM/GPRS, or 4G cellular communication, such as WiMAX or LTE. Alternatively, the wireless communication system 146 may communicate with a wireless local area network (WLAN) using WiFi or other possible connections. The wireless communication system 146 may also communicate directly with a device using an infrared link, Bluetooth, or ZigBee, for example. Other wireless protocols, such as various vehicular communication systems, are possible within the context of the disclosure. For example, the wireless communication system 146 may include one or more dedicated short-range communications (DSRC) devices that could include public and/or private data communications between vehicles and/or roadside stations.

The vehicle 100 may include the power supply 110 for powering components. The power supply 110 may include a rechargeable lithium-ion or lead-acid battery in some implementations. For instance, the power supply 110 may include one or more batteries configured to provide electrical power. The vehicle 100 may also use other types of power supplies. In an example implementation, the power supply 110 and the energy source 119 may be integrated into a single energy source.

The vehicle 100 may also include the computer system 112 to perform operations, such as operations described therein. As such, the computer system 112 may include at least one processor 113 (which could include at least one microprocessor) operable to execute instructions 115 stored in a non-transitory computer readable medium, such as the data storage 114. In some implementations, the computer system 112 may represent a plurality of computing devices that may serve to control individual components or subsystems of the vehicle 100 in a distributed fashion.

In some implementations, the data storage 114 may contain instructions 115 (e.g., program logic) executable by the processor 113 to execute various functions of the vehicle 100, including those described above in connection with FIG. 1. The data storage 114 may contain additional instructions as well, including instructions to transmit data to, receive data from, interact with, and/or control one or more of the propulsion system 102, the sensor system 104, the control system 106, and the peripherals 108.

In addition to the instructions 115, the data storage 114 may store data such as roadway maps, path information, among other information. Such information may be used by the vehicle 100 and the computer system 112 during the operation of the vehicle 100 in the autonomous, semi-autonomous, and/or manual modes.

The vehicle 100 may include the user interface 116 for providing information to or receiving input from a user of the vehicle 100. The user interface 116 may control or enable control of content and/or the layout of interactive images that could be displayed on the touchscreen 148. Further, the user interface 116 could include one or more input/output devices within the set of peripherals 108, such as the wireless communication system 146, the touchscreen 148, the microphone 150, and the speaker 152.

The computer system 112 may control the function of the vehicle 100 based on inputs received from various subsystems (e.g., the propulsion system 102, the sensor system 104, and the control system 106), as well as from the user interface 116. For example, the computer system 112 may utilize input from the sensor system 104 in order to estimate the output produced by the propulsion system 102 and the control system 106. Depending upon the implementation, the computer system 112 could be operable to monitor many aspects of the vehicle 100 and its subsystems. In some implementations, the computer system 112 may disable some or all functions of the vehicle 100 based on signals received from the sensor system 104.

The components of the vehicle 100 could be configured to work in an interconnected fashion with other components within or outside their respective systems. For instance, in an example implementation, the camera 130 could capture a plurality of images that could represent information about a state of an environment of the vehicle 100 operating in an autonomous mode. The state of the environment could include parameters of the road on which the vehicle is operating. For example, the computer vision system 140 may be able to recognize the slope (grade) or other features based on the plurality of images of a roadway. Additionally, the combination of the GPS 122 and the features recognized by the computer vision system 140 may be used with map data stored in the data storage 114 to determine specific road parameters. Further, the radar unit 126 may also provide information about the surroundings of the vehicle.

In other words, a combination of various sensors (which could be termed input-indication and output-indication sensors) and the computer system 112 could interact to provide an indication of an input provided to control a vehicle or an indication of the surroundings of a vehicle.

In some implementations, the computer system 112 may make a determination about various objects based on data that is provided by systems other than the radio system. For example, the vehicle 100 may have lasers or other optical sensors configured to sense objects in a field of view of the vehicle. The computer system 112 may use the outputs from the various sensors to determine information about objects in a field of view of the vehicle, and may determine distance and direction information to the various objects. The computer system 112 may also determine whether objects are desirable or undesirable based on the outputs from the various sensors.

Although FIG. 1 shows various components of the vehicle 100, i.e., the wireless communication system 146, the computer system 112, the data storage 114, and the user interface 116, as being integrated into the vehicle 100, one or more of these components could be mounted or associated separately from the vehicle 100. For example, the data storage 114 could, in part or in full, exist separate from the vehicle 100. Thus, the vehicle 100 could be provided in the form of device elements that may be located separately or together. The device elements that make up the vehicle 100 could be communicatively coupled together in a wired and/or wireless fashion.

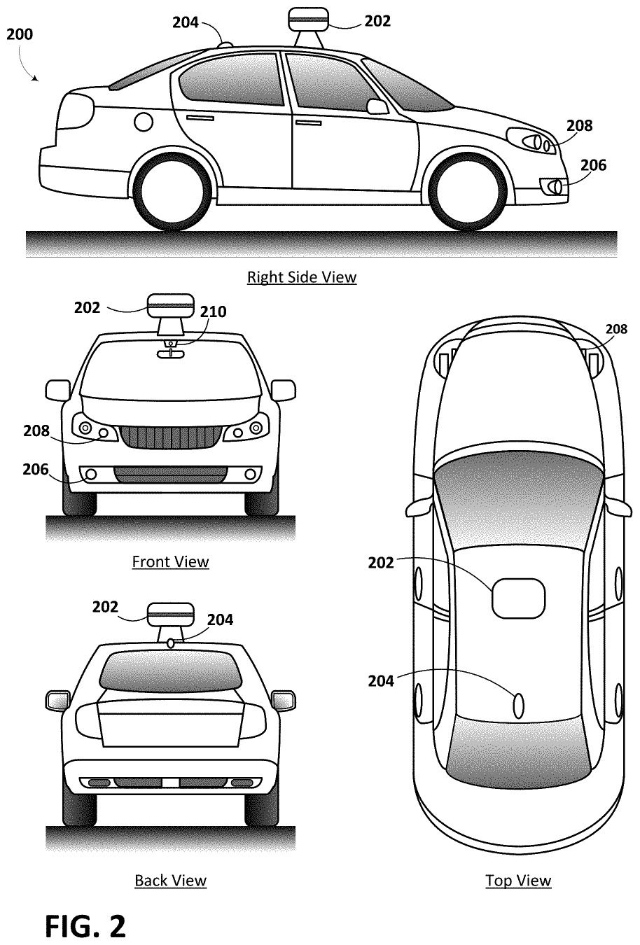

FIG. 2 depicts an example physical configuration of the vehicle 200, which may represent one possible physical configuration of vehicle 100 described in reference to FIG. 1. Depending on the implementation, the vehicle 200 may include the sensor unit 202, the wireless communication system 204, the radio unit 206, the deflectors 208, and the camera 210, among other possible components. For instance, the vehicle 200 may include some or all of the elements of components described in FIG. 1. Although the vehicle 200 is depicted in FIG. 2 as a car, the vehicle 200 can have other configurations within examples, such as a truck, a van, a semi-trailer truck, a motorcycle, a golf cart, an off-road vehicle, or a farm vehicle, among other possible examples.

The sensor unit 202 may include one or more sensors configured to capture information of the surrounding environment of the vehicle 200. For example, the sensor unit 202 may include any combination of cameras, radars, LIDARs, range finders, radio devices (e.g., Bluetooth and/or 802.11), and acoustic sensors, among other possible types of sensors. In some implementations, the sensor unit 202 may include one or more movable mounts operable to adjust the orientation of sensors in the sensor unit 202. For example, the movable mount may include a rotating platform that can scan sensors so as to obtain information from each direction around the vehicle 200. The movable mount of the sensor unit 202 may also be movable in a scanning fashion within a particular range of angles and/or azimuths.

In some implementations, the sensor unit 202 may include mechanical structures that enable the sensor unit 202 to be mounted atop the roof of a car. Additionally, other mounting locations are possible within examples.

The wireless communication system 204 may have a location relative to the vehicle 200 as depicted in FIG. 2, but can also have different locations within implementations. The wireless communication system 200 may include one or more wireless transmitters and one or more receivers that may communicate with other external or internal devices. For example, the wireless communication system 204 may include one or more transceivers for communicating with a user's device, other vehicles, and roadway elements (e.g., signs, traffic signals), among other possible entities. As such, the vehicle 200 may include one or more vehicular communication systems for facilitating communications, such as dedicated short-range communications (DSRC), radio frequency identification (RFID), and other proposed communication standards directed towards intelligent transport systems.

The camera 210 may have various positions relative to the vehicle 200, such as a location on a front windshield of vehicle 200. As such, the camera 210 may capture images of the environment of the vehicle 200. As illustrated in FIG. 2, the camera 210 may capture images from a forward-looking view with respect to the vehicle 200, but other mounting locations (including movable mounts) and viewing angles of the camera 210 are possible within implementations. In some examples, the camera 210 may correspond to one or more visible light cameras. Alternatively or additionally, the camera 210 may include infrared sensing capabilities. The camera 210 may also include optics that may provide an adjustable field of view.

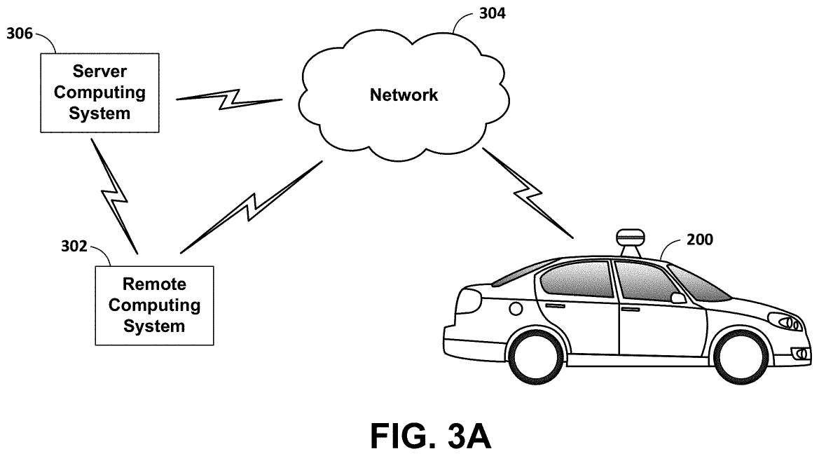

FIG. 3A is a conceptual illustration of wireless communication between various computing systems related to an autonomous vehicle, according to an example implementation. In particular, wireless communication may occur between a remote computing system 302 and the vehicle 200 via a network 304. Wireless communication may also occur between a server computing system 306 and the remote computing system 302, and between the server computing system 306 and the vehicle 200.

The vehicle 200 can correspond to various types of vehicles capable of transporting passengers or objects between locations, and may take the form of any one or more of the vehicles discussed above. In some instances, the vehicle 200 may operate in an autonomous mode that enables a control system to safely navigate the vehicle 200 between destinations using sensor measurements. When operating in an autonomous mode, the vehicle 200 may navigate with or without passengers. As a result, the vehicle 200 may pick up and drop off passengers between desired destinations.

The remote computing system 302 may represent any type of device related to remote assistance techniques, including but not limited to those described herein. Within examples, the remote computing system 302 may represent any type of device configured to (i) receive information related to the vehicle 200, (ii) provide an interface through which a human operator can in turn perceive the information and input a response related to the information, and (iii) transmit the response to vehicle 200 or to other devices. The remote computing system 302 may take various forms, such as a workstation, a desktop computer, a laptop, a tablet, a mobile phone (e.g., a smart phone), and/or a server. In some examples, the remote computing system 302 may include multiple computing devices operating together in a network configuration.

The remote computing system 302 may include one or more subsystems and components similar or identical to the subsystems and components of vehicle 200. At a minimum, the remote computing system 302 may include a processor configured for performing various operations described herein. In some implementations, the remote computing system 302 may also include a user interface that includes input/output devices, such as a touchscreen and a speaker. Other examples are possible as well.

The network 304 represents infrastructure that enables wireless communication between the remote computing system 302 and the vehicle 200. The network 304 also enables wireless communication between the server computing system 306 and the remote computing system 302, and between the server computing system 306 and the vehicle 200.

The position of the remote computing system 302 can vary within examples. For instance, the remote computing system 302 may have a remote position from the vehicle 200 that has a wireless communication via the network 304. In another example, the remote computing system 302 may correspond to a computing device within the vehicle 200 that is separate from the vehicle 200, but with which a human operator can interact while a passenger or driver of the vehicle 200. In some examples, the remote computing system 302 may be a computing device with a touchscreen operable by the passenger of the vehicle 200.

In some implementations, operations described herein that are performed by the remote computing system 302 may be additionally or alternatively performed by the vehicle 200 (i.e., by any system(s) or subsystem(s) of the vehicle 200). In other words, the vehicle 200 may be configured to provide a remote assistance mechanism with which a driver or passenger of the vehicle can interact.

The server computing system 306 may be configured to wirelessly communicate with the remote computing system 302 and the vehicle 200 via the network 304 (or perhaps directly with the remote computing system 302 and/or the vehicle 200). The server computing system 306 may represent any computing device configured to receive, store, determine, and/or send information relating to the vehicle 200 and the remote assistance thereof. As such, the server computing system 306 may be configured to perform any operation(s), or portions of such operation(s), that is/are described herein as performed by the remote computing system 302 and/or the vehicle 200. Some implementations of wireless communication related to remote assistance may utilize the server computing system 306, while others may not.

The server computing system 306 may include one or more subsystems and components similar or identical to the subsystems and components of the remote computing system 302 and/or the vehicle 200, such as a processor configured for performing various operations described herein, and a wireless communication interface for receiving information from, and providing information to, the remote computing system 302 and the vehicle 200.

The various systems described above may perform various operations. These operations and related features will now be described. In line with the discussion above, a computing system (e.g., the remote computing system 302, or perhaps the server computing system 306, or a computing system local to the vehicle 200) may operate sensor-capture devices to capture sensor information (e.g., a camera to capture images) of the environment of an autonomous vehicle. In general, at least one computing system will be able to analyze the sensor information and possibly control the autonomous vehicle.

In some implementations, to facilitate autonomous operation a vehicle (e.g., the vehicle 200) may receive data representing objects in an environment in which the vehicle operates (also referred to herein as “environment data”) in a variety of ways. A sensor system on the vehicle may provide the environment data representing objects of the environment. For example, the vehicle may have various sensors, including a camera, a radar unit, a laser range finder, a microphone, a radio unit, and other sensors. Each of these sensors may communicate environment data to a processor in the vehicle about information each respective sensor receives.

In one example, a camera may be configured to capture still images and/or video. In some implementations, the vehicle may have more than one camera positioned in different orientations. Also, in some implementations, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar unit may be configured to transmit an electromagnetic signal that will be reflected by various objects near the vehicle, and then capture electromagnetic signals that reflect off the objects. The captured reflected electromagnetic signals may enable the radar system (or processing system) to make various determinations about objects that reflected the electromagnetic signal. For example, the distance and position to various reflecting objects may be determined. In some implementations, the vehicle may have more than one radar in different orientations. The radar system may be configured to store captured information to a memory for later processing by a processing system of the vehicle. The information captured by the radar system may be environment data.

In another example, a laser range finder may be configured to transmit an electromagnetic signal (e.g., light, such as that from a gas or diode laser, or other possible light source) that will be reflected by a target objects near the vehicle. The laser range finder may be able to capture the reflected electromagnetic (e.g., laser) signals. The captured reflected electromagnetic signals may enable the range-finding system (or processing system) to determine a range to various objects. The range-finding system may also be able to determine a velocity or speed of target objects and store it as environment data.

Additionally, in an example, a microphone may be configured to capture audio of environment surrounding the vehicle. Sounds captured by the microphone may include emergency vehicle sirens and the sounds of other vehicles. For example, the microphone may capture the sound of the siren of an emergency vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some implementations it is desirable to transmit the first electromagnetic radiation signal with a signaling mode that requests a response from devices located near the autonomous vehicle. The processing system may be able to detect nearby devices based on the responses communicated back to the radio unit and use this communicated information as a portion of the environment data.

In some implementations, the processing system may be able to combine information from the various sensors in order to make further determinations of the environment of the vehicle. For example, the processing system may combine data from both radar information and a captured image to determine if another vehicle or pedestrian is in front of the autonomous vehicle. In other implementations, other combinations of sensor data may be used by the processing system to make determinations about the environment.

While operating in an autonomous mode, the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the environment (e.g., if there is actually a stop sign or if there is actually no stop sign present), (ii) confirm whether the vehicle's identification of the object is correct, (iii) correct the identification if the identification was incorrect and/or (iv) provide a supplemental instruction (or modify a present instruction) for the autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

To facilitate this, the vehicle may analyze the environment data representing objects of the environment to determine at least one object having a detection confidence below a threshold. A processor in the vehicle may be configured to detect various objects of the environment based on environment data from various sensors. For example, in one implementation, the processor may be configured to detect objects that may be important for the vehicle to recognize. Such objects may include pedestrians, street signs, other vehicles, indicator signals on other vehicles, and other various objects detected in the captured environment data.

The detection confidence may be indicative of a likelihood that the determined object is correctly identified in the environment, or is present in the environment. For example, the processor may perform object detection of objects within image data in the received environment data, and determine that the at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the environment in various way depending on the source of the environment data. In some implementations, the environment data may come from a camera and be image or video data. In other implementations, the environment data may come from a LIDAR unit. The vehicle may analyze the captured image or video data to identify objects in the image or video data. The methods and apparatuses may be configured to monitor image and/or video data for the presence of objects of the environment. In other implementations, the environment data may be radar, audio, or other data. The vehicle may be configured to identify objects of the environment based on the radar, audio, or other data.

In some implementations, the techniques the vehicle uses to detect objects may be based on a set of known data. For example, data related to environmental objects may be stored to a memory located in the vehicle. The vehicle may compare received data to the stored data to determine objects. In other implementations, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other implementations, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some implementations, the vehicle may react as if the detected object is present despite the low confidence level. In other implementations, the vehicle may react as if the detected object is not present.

When the vehicle detects an object of the environment, it may also calculate a confidence associated with the specific detected object. The confidence may be calculated in various ways depending on the implementation. In one example, when detecting objects of the environment, the vehicle may compare environment data to predetermined data relating to known objects. The closer the match between the environment data to the predetermined data, the higher the confidence. In other implementations, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304), and in some implementations, via a server (e.g., server computing system 306). The human operator of the remote computing system may in turn use the environment data as a basis for responding to the request.

In some implementations, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of vehicle (e.g., a speed and/or direction), among other possible adjustments.

In other implementations, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

FIG. 3B shows a simplified block diagram depicting components of an example camera system or an image capture device 350. The camera system 350 may correspond to the camera 130 of FIG. 1. In some examples, the vehicle may include more than one camera system 350. For example, a vehicle may include one camera system mounted to a top of the vehicle in a sensor dome and another camera system located behind the windshield of the vehicle. In other examples, the various camera system may be located in various different positions throughout the vehicle.

The camera system 350 may include one or more processors 352, a system memory 354, a memory buffer or storage device 355, and one or more image sensors 356. Although various components of the camera system 350 are shown as distributed components, it should be understood that any of such components may be physically integrated and/or distributed according to the desired configuration of the computing system.

The one or more processors 352 of the camera system 350 may receive image data from the one or more image sensors 356 and may perform image processing on the image data. For example, the one or more processors 352 may perform filtering, cropping, demosaicing, compression, image enhancement, or other processing of the image data captured by the one or more image sensors 356. Depending on the desired configuration, the one or more processors 352 may include any type of processor including, but not limited to, a microprocessor (μP), a microcontroller (μC), a digital signal processor (DSP), image processor, or any combination thereof.

The system memory 354 of the camera system 354 may be any type of memory including but not limited to volatile memory (such as RAM), non-volatile memory (such as ROM, flash memory, etc.) or any combination thereof. In some examples, the system memory 354 may be a memory cache to temporarily store image data. The system memory 354 may include program instructions 360 that are executable by the one or more processors 352 to facilitate the various functions described herein. For example, image and/or video compression algorithms may be stored in the system memory 354 and executed by the one or more processors 352.

The one or more image sensors 356 of the camera system 350 may capture images and route the images to the memory buffer 355 and/or the one or more processors 352. The routing of the images from the one or more image sensors 356 to the memory buffer or the one or more processors 352 may be controlled by software rather than exclusively by a physical connection. In some examples, the one or more image sensors 356 may be located near the one or more processors 352. For example, the electrical distance (i.e. the distance as measured along the electrical traces) between the one or more image sensors 356 and the processors 352 may be on the order of a few inches.

The memory buffer 355 of the camera system 350 may be communicatively coupled to the one or more image sensors 356 and the one or more processors 352. In some embodiments, the memory buffer 355 may be part of the processor 352 or the system memory 354. The memory buffer 355 may be configured to reorder the image data generated from the one or more image sensors 356. The memory buffer 355 may receive a sequence of images in a data stream from the one or more image sensors 356. Each image of the sequence may include a plurality of data elements that may be received by the memory buffer 356 in a serial order. For example, the data elements of each image may be input into the memory buffer 355 in a row-major or row-wise serial order. When the memory buffer 355 receives the data elements of an image of the sequence, the data elements of the image may be written in a series of memory locations of the memory buffer in an order according to a first address sequence. For example, the data elements of the image may be serially written to the memory buffer 355 in a row-major or row-wise serial order.

Once the data elements of the image are stored in the memory buffer 355, the data elements of the image may be read from the memory buffer 355 according to a second address sequence. For example, the data elements of the image may be serially read from the memory buffer 355 in a column-major order or column-wise order. After the data elements of the first image have been read memory locations of the from the memory buffer 355, the memory buffer 355 may output the data elements in the column-major order in a data stream and data elements of a second image in the sequence may be written in the memory buffer 355. The data elements of the second image may be reordered according to the process described above. As such, the memory buffer 355 may receive the data elements of each successive image in a row-major or row-wise serial order and output the data elements in a column-major or column-wise serial order.

Referring still to FIG. 3B, the camera system 350 may include a system bus 357 that communicatively couples the one or more processors 352 with an external computing device 358. The external computing device 358 may be used for longer term storage and/or processing of images. The external computing device 358 may be configured with a larger memory than the system memory 354 of the camera system 350. For example, image data in the external computing device 358 may be used by a navigation system (e.g. navigation processor) of the autonomous vehicle. The external computing device 358 may be located in the vehicle itself, but as a separate system from the camera system 350. The external computing device 358 may include a vehicle-control processor 360, memory 362, communication system 364, and other components. The communication system 364 may be configured to communicate data between the vehicle and a remote computer server.

FIG. 3C is a conceptual illustration of an imaging operation of an apparatus 380 that includes an optical system 382 (e.g., a lens) and an image sensor 384. The apparatus 380 may comprises an image capture device, such as camera system 350 shown in FIG. 3B. The optical system 382 of the apparatus 380 provides an overall field of view 386 to the image sensor 384. The overall field of view 386 includes a vertical field of view 388 and a horizontal field of view 390. The overall field of view 386 corresponds to the largest angular extent that the image sensor 384 can image via the optical system 382.

In some examples, at least one portion of the image sensor 384 may be disabled. When at least one portion of the image sensor 384 is disabled, the field of view may be only a portion of the overall field of view 386. As an example, when two portions of the image sensor 384 are disabled, there may be an imaged field of view 392, a top disabled portion of the field of view 394A, and a bottom disabled portion of the field of view 394B. The top disabled portion of the field of view 394A and the bottom disabled portion of the field of view 394B may correspond to the two disabled regions of the image sensor 384.

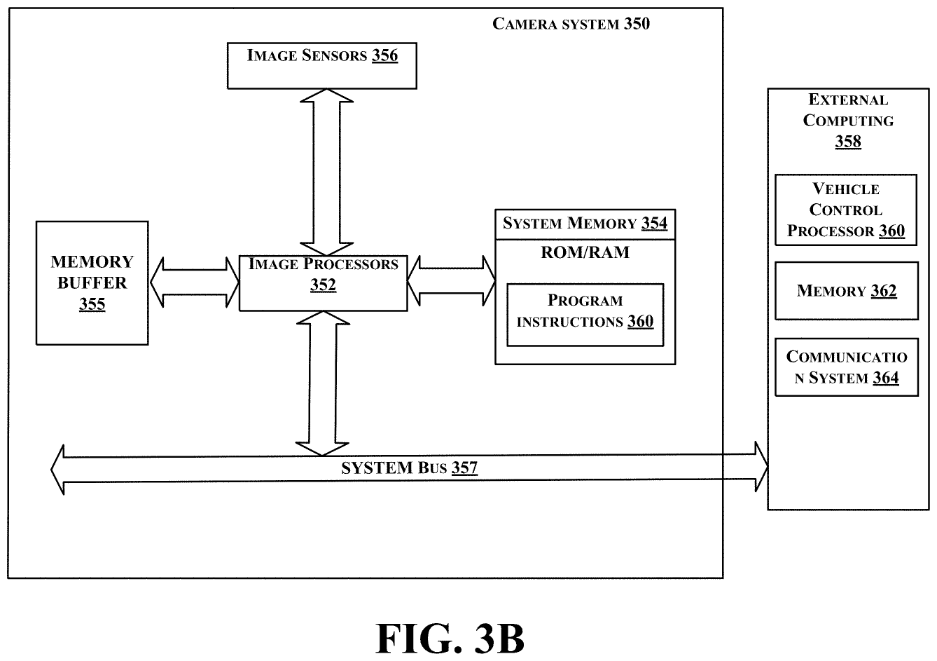

FIG. 4 illustrates an image sensor 400 of an image capture device, such as an image sensor of the camera system 350 of FIG. 3B. The image sensor 400 may be a Complementary Metal-Oxide-Semiconductor (CMOS) image sensor or other similar type of image sensor. The image sensor 400 may comprise a two-dimensional grid or array 402 of pixel elements or sensor cells 404 to enable the construction or formation an image of a scene. The pixel array 402 may be M pixels wide by N pixels tall and each pixel element 404 may define a pixel area having a pixel width and a pixel height.

As shown in FIG. 4, the array 402 of pixel elements 404 may be arranged to form N-rows 410 (indexed from 0 to N−1) of pixel elements 404 and M-columns 412 (indexed from 0 to M−1) of pixel elements 404. The array 402 of pixel elements 404 may include a first pixel element P_{0,0} at the upper left corner of the array 402 and a last pixel element P_{N-1,M-1} at the lower right corner of the array 402. As such, the array 402 of the image sensor 400 may include a first row with pixel elements P_{0,0}-P_{0,M-1}, a second row with pixel elements P_{1,0}-P_{1,M-1}, and a last N−1 row with pixel elements P_{N-1,0}-P_{N-1,M-1}. Further, the array 402 includes a first column with pixel elements P_{0,0}-P_{N-1,0}, a second column with pixel elements P_{0,1}-P_{N-1,1}, and a last M−1 column with pixel elements P_{0,M-1}-P_{N-1,M-1}. In some examples, the array 402 of the image sensor 400 may be configured as a square array with the same number of rows and columns. In other examples, the array 402 may be configured as a rectangular array with a different number of rows and columns. For example, the array 402 may be wider than it is tall (e.g., may have more vertical columns than horizontal rows).

During operation, the pixel elements 404 of the image sensor 400 may receive light by way of an optical system and convert the light into electrical signals. The electrical signals may correspond to the color and intensity of light that is received by the pixel elements 404. In order to construct or form an image of a scene or a portion of the scene, a processor, such as the processor described with respect to FIG. 1 and/or FIG. 3B, may be configured to sample or scan the pixel elements 404 of image sensor 400. For example, the pixel elements 400 may be sampled or scanned one row at a time. Sampling in this way is known as a rolling shutter. Further, the pixel elements 404 may be sampled in an iterative fashion by incrementally adjusting the sample row. In some examples, the iterations may be linear, that is after each row is sampled, the next row is subsequently sampled. In other examples, the sampling may be performed in different ways. For example, the pixel elements of the image sensor 400 may be sampled more than one row at a time. Further, the sampling may be performed on columns in a sequential or non-sequential order.

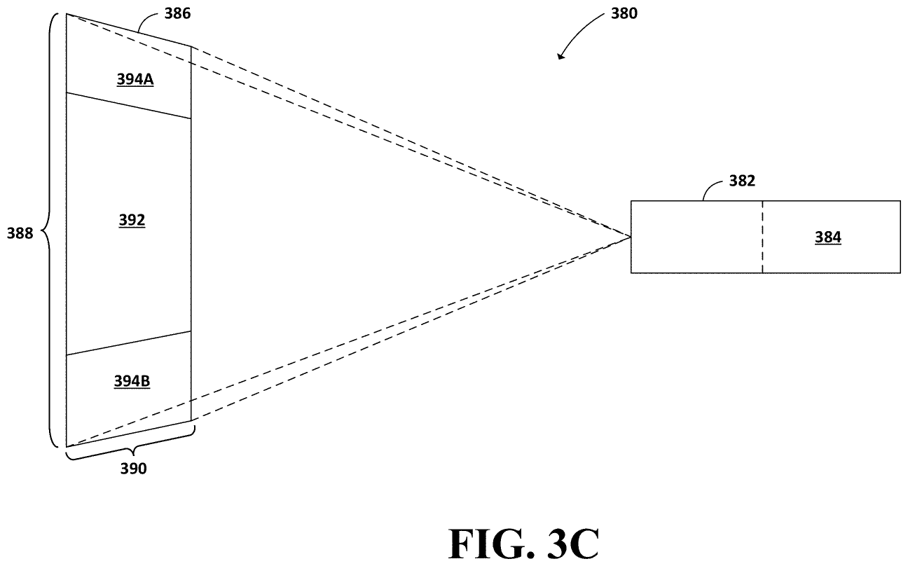

When the pixel elements 404 of the image sensor 400 are sampled, the image data (e.g., pixel values) associated with each pixel elements 404 may be captured. FIG. 5 illustrates a conceptual representation of a two-dimensional image or image frame 500 (e.g., a still image or single image frame of a video sequence) captured by the image sensor 400 of FIG. 4. As shown in FIG. 5, the image 500 captured by the image senor 400 may be represented by a matrix 502 of data elements 504. The data elements 504 of the image 500 may be arranged in N-rows 510 (indexed from 0 to N−1) of data elements 504, and M-columns 512 (indexed from 0 to M−1) of data elements 504. The dimensions of the image 500 may correspond to the dimensions of the array 402 of the image sensor 400.

As shown in FIG. 5, the data elements 504 of the image 500 may be arranged with a data element I_{0,0} at the upper left corner of the matrix 502 of the image 500 and a last element I_{N-1,M-1} at the lower right corner of the matrix 502. As such, the image 500 may include a first row with the data elements I_{0,0}-I_{0,M-1}, a second row with the data elements and a last N−1 row with the data elements I_{N-1,0}-I_{N-1,M-1}. Further, the image 500 may include a first column with the data elements I_{0,0}-I_{N-1,0}, a second column with the data elements I_{0,1}-I_{N-1,1}, and a last M−1 column with data elements I_{0,M-1}-I_{N-1,M-1}.

After obtaining the data elements 504 of the image 500 captured by the image sensor 400, the data elements 504 of the image 500 may be organized in a data stream and transmitted to a memory buffer or a storage device, such as the memory buffer 355 of FIG. 3B. The data elements 504 of each image may be arranged or organized in the data stream in a serial order corresponding to the order that the pixel elements or sensor cells of the image sensor 400 have been sampled or scanned. Each image in the sequence may include a number of data elements that is a product of multiplying the number of rows of the image by the number of columns. Further, each image may have the same dimensions and may have the same number of data elements.

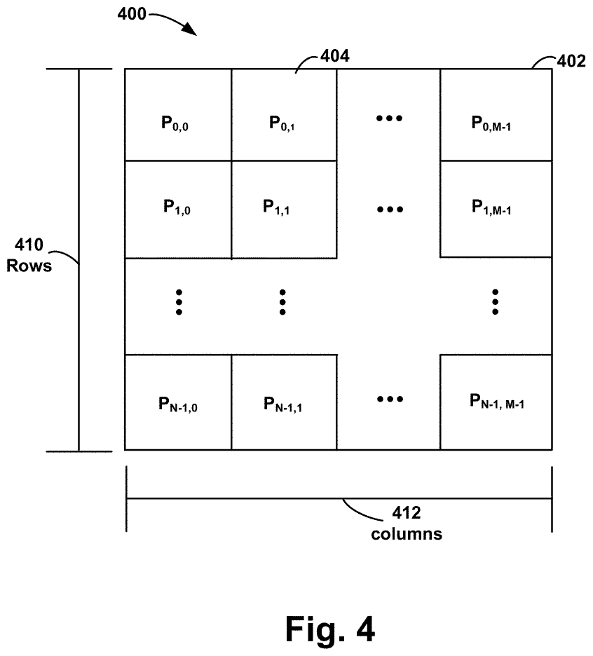

When the pixel elements 404 of the image sensor 400 are sampled from left-to-right, top-to-bottom, the data elements of each image may be arranged or organized in consecutive groups of rows in the data stream (e.g., a row-by-row format or row-wise format). For example, the data elements of the image 500 may arranged in the data stream beginning with the data elements I_{0,0}-I_{0,M-1} from the first row, followed by the data elements I_{1,0}-I_{1,M-1} from the second row, and followed by the data elements I_{N-1,0}-I_{N-1,M-1} from the N−1 row of the image 500. As such, the data elements of the image 500 may be arranged in the data stream in a row-major or row-wise serial order of I_{0,0}, I_{0.1}, . . . I_{0,M-1}, I_{1,0}, I_{1,1}, . . . I_{1,M-1}, I_{N-1,0}, I_{N-1,1}, . . . and I_{N-1,M-1} as shown in FIG. 6. The data elements of the image 600 may then be sent in the data stream to a memory buffer or storage device for reordering.

When the data elements of the image 400 are received at the memory buffer, the data elements of the image 400 may be written to a series of memory locations in the memory buffer in a row-major or row-wise order. However, in some implementations, accessing the data elements of an image in row-major or row-wise order may not be efficient for processing image data. In some applications, it may be desirable to operate on the data elements of the image in a column format to perform computationally intensive functions, such as fast Fourier transforms and discrete cosine transforms (DCT). For example, when compressing images, a one dimension DCT may operate on the rows of an image and then operate on the columns of the image. Thus, reordering the data elements of the image 400 from a row-wise serial order to a column-wise serial order may increase the speed and improve the efficiency of compressing images.

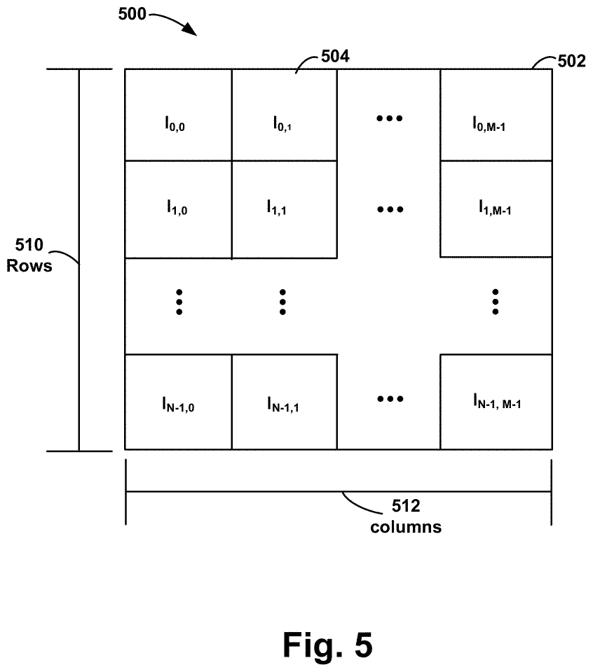

In exemplary implementations, a memory buffer may receive the data elements of the image 400 in a row-major order and reorder the data elements of the image in a column-major order of I_{0,0}, I_{1.0}, . . . I_{N-1,0}, I_{0,1}, I_{1,1}, . . . I_{N-1,1}, I_{0,M-1}, I_{1,M-1}, . . . and I_{N-1,M-1} as shown in FIG. 7. After the data elements of the image 400 are read out in column-wise serial order, the data elements may be stored in a memory in a column-wise order and used for image processing, as further discussed below.

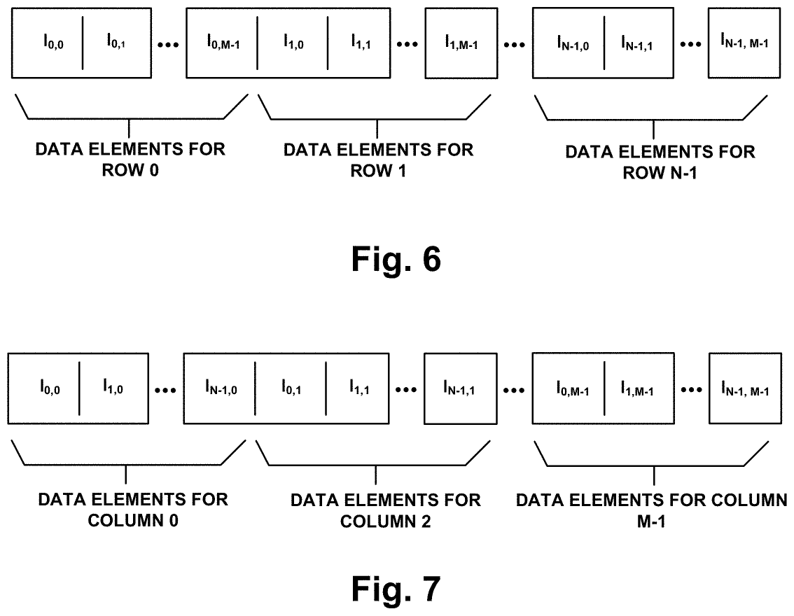

FIG. 8 shows a block diagram illustrating an example of an apparatus 800 that may be configured to utilize techniques for rearranging or reordering image data in accordance with the principles of the present disclosure. In one embodiment, the apparatus 800 may correspond to the memory buffer 355 of FIG. 3B. In other embodiments, the apparatus 800 may be part of the processors 352 or the system memory 354 of FIG. 3B. The apparatus 800 may be configured to consecutively reorder each image of a sequence of images in a data stream. For example, the apparatus 800 may receive image data and reorder the image data in a different order than received by the apparatus 800. The apparatus 800 may enable the use of a memory buffer with reduced capacity for reordering image data than may otherwise be required using traditional memory architectures having two memory banks. For example, the apparatus 800 may reorder the image data by using a memory buffer with the capacity to store a single image at one time, which allows for more efficient memory utilization than traditional memory architectures that usually require a memory capacity for storing at least two images at one time.

As shown in FIG. 8, the apparatus 800 may receive a data stream that may include a sequence of images. Each image in the sequence may include a number of data elements that is a product of multiplying the numbers of columns of the image by the number of rows. In some implementations, the data elements of each image in the sequence may have the same number of data elements. The data elements of an image may be received in a first serial order and may be outputted in a second serial order. For example, the data elements of the image may be input into the apparatus in a row-by-row format (e.g., a row-major or row-wise serial order). The apparatus may write the data elements of the image in a row-wise order to a series of memory locations of a memory.

Once the data elements of the image are stored in the memory, the data elements of the image may be read in an order different than the order that the data elements were written in the memory. For example, the data elements of the image may be read in a column-major or column-wise order from the memory. After the data elements of the first image have been read from the memory, the data elements may be outputted from the apparatus 800 in a column-major or column-wise serial order and data elements of a second image in the sequence of images may be written in the memory. The process may be repeated to reorder the data elements of the second image in the sequence. As a result, the apparatus 800 may receive the data elements of the second image in a row-major or row-wise serial order and may reorder data elements of the second image in a column-major or column-wise serial order.

As shown in FIG. 8, the apparatus 800 may include a memory buffer or storage device 802 for storing an image of a sequence of images. The memory buffer 802 includes a memory array 804, an address generator 806, and control circuitry, such as a write unit 808 and a read unit 810. The memory array 804 of the memory buffer 802 may be configured to receive the data elements of an image and store the data elements in the memory array 804 in a row-major order or a row-wise order. The memory array 804 may include memory locations or cells 812, such as memory storage elements or registers. Each of the memory locations 812 may be configured to store a single bit or multiple bits of data (e.g., image data or pixel values).

The memory locations 812 of the memory array 804 may be arranged as a two-dimensional matrix or array of random access memory (RAM) or other addressable memory. For example, the two-dimensional array may include X-columns and Y-rows. The number of memory locations 812 may be equal to the number of data elements in each image of the sequence. In some embodiments, the number of memory locations 812 may be greater than the number of data elements in each image in the sequence; however, the number of memory locations that may be utilized may equal the number of data elements in each image in the sequence. As a result, the number of memory locations used to reorder each image may be significantly less than the number of memory locations used in traditional reordering techniques. Thus, the size of the memory buffer 802 for reordering image data may be reduced and memory power consumption may be decreased.

As shown in FIG. 8, the address generator 806 of the memory buffer 802 may be coupled to the write unit 808 and the read unit 810. In some embodiments, the address generator may be part of the one or more image processors 352 of FIG. 3B. The address generator 806 may generate addresses for performing read and write accesses operations, such that the data elements of a two-dimensional image may be written in the memory buffer 802 in a first order during a write operation and the data elements of the image may be retrieved in a second order during a read operation. The addresses may be within a range of zero through one less than the number of memory locations in the memory array 804.

For memory write operations, the address generator 806 may generate addresses to select the memory locations 802 of the memory array 804 for writing the data elements of an image. For example, the address generator 806 may generate a series or sequence of addresses associated with the memory locations 812 of the memory array 804 for serially writing the data elements in row-major order. For memory read operations, the address generator may be configured to generate addresses for selecting memory locations to serially read the data elements of the image from the memory locations 812 of the memory array 804. For example, the address generator may generate a series of addresses for reading the memory locations that store the data elements of the image. When the data elements of the image are stored in an uncompressed format, the address generator can determine the memory locations 812 storing each of the data elements of the image based on the data element layout order of the image (e.g., a row or column-major order).

In order to rearrange a given size memory array of data elements received in a row-wise order to a column-wise order, the address generator may generate addresses according to the following expression:

address=address+step

if (address>=buffer_size), then

address=address−buffer_size+1

In the foregoing expression, buffer_size represents the number of memory locations of the memory array, width represents the width of the image, and height represents the height of the image. At the beginning of the rearranging process, the address value is initialized to zero and the step value is initialized to one. Once the data elements of the image have been received, the step may be updated according to the following expression:

step=width*mod(step/height)+quotient(step/height)

In the above expression, mod is the remainder of an integer division and quotient is the quotient of an integer division. As a result, the address generator 806 may generate a sequence or series of addresses to write the data elements of the image in a row-wise order to the memory locations 812 of the memory array and read the data elements of the image in a column-wise order from the memory locations 812 of the memory array 804. Thus, the data elements of the image may be reordered from a row-major order to a column-major order.

As shown in FIG. 8, the write unit 808 of the memory buffer 802 may be coupled to the memory array 804 for performing write operations. The write unit 808 may include logic gates and/or logic elements. The write unit 808 receives the data elements of the images that are input into the memory buffer 802. For example, the write unit 802 may receive consecutive rows of the data elements of an image I_{0,0}-I_{N-1,M-1}, wherein I₀ is the first data element of the image, and I_{N-1, M-1} is the last data element of the image.

During write operations, the write unit 808 of the memory buffer 802 generates write select signals 812 for selecting the memory locations 812 of the memory array 804 and writes the data elements of the image to the memory locations 812 based on addresses from the address generator 806. For example, each of the rows of the memory array 804 may be addressable by a row address and each of the columns of the memory array 804 may be addressable by a column address. As such, the write unit 804 selects the memory locations 812 in the memory array 804 and writes the data elements of the image to the memory locations 812. The write unit 808 may write one data element to each memory location for an address received from the address generator 806. In one embodiment, the write unit 808 may serially write the data elements of the image in the memory array 804 in the order received by the memory buffer 802. As a result, the write unit 808 may write the data elements of the image to the memory locations in a row-major order or a row-wise order.

The read unit 810 of the memory buffer 802 may be coupled to the output of the memory array 802 for performing read operations. The read unit 810 may include logic gates and/or logic elements. Once the data elements of an image are written to the memory locations 812 of the memory array 804, the read unit 810 may read the data elements of the image. The read unit 810 may be configured to serially read the data elements of the image stored in the memory array 804 in an output order that may be different from the input order of the data elements. The read unit 810 may read the data elements of the image stored in the memory array 804 according to read addresses generated by the address generator 806.

During read operations, the read unit 810 of the memory buffer 802 may generate a read select signal for selecting memory locations 812 of the memory array 804 and for reading the data elements of the image from the memory locations 812 based on addresses generated from address generator 806. For example, each of the rows of the memory array 804 may be addressable by a row address and each of the columns of the memory array 804 may be addressable by a column address. The read unit 810 may read one data element from a memory location for each address received from the address generator 806. In exemplary implementations, the read unit 810 may read the data elements of the image in a different serial order than the order that the data elements were stored. For example, the read unit 810 may read the data elements of the image stored in the memory array 804 in a column-major or a column-wise order of I_{0,0}, I_{1.0}, . . . I_{N-1,0}, I_{0,1}, I_{1,1}, . . . I_{N-1,1}, I_{0,M-1}, I_{1,M-1}, . . . and I_{N-1,M-1}.

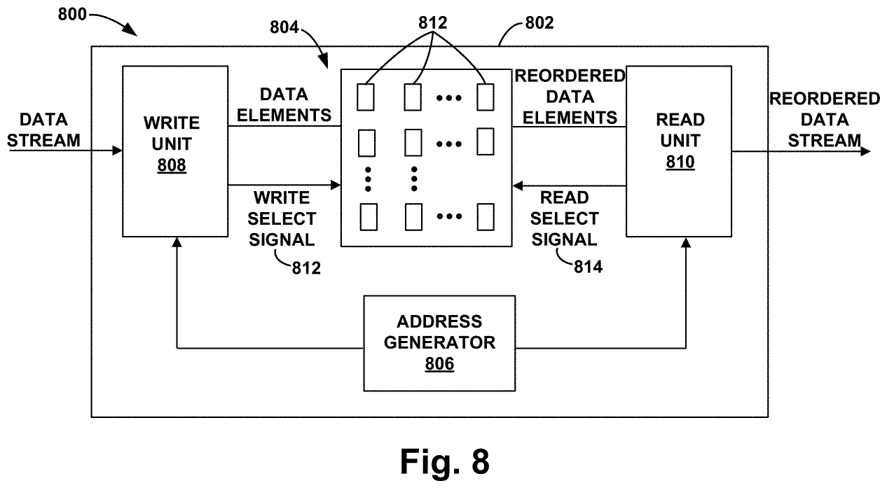

FIG. 9 is a flow chart of a method 900 for reordering or rearranging image data of a sequence of images in a data stream, according to an example implementation. Method 900 represents an example method that may include one or more operations as depicted by one or more blocks 902-918, each of which may be carried out by any of the systems shown in FIGS. 1-3 and 8, among other possible systems. In an example implementation, an image system (e.g., an image capture device) or a computing system (e.g., a camera system 350) performs the illustrated operations, although in other implementations, one or more other systems (e.g., server computing system 306) can perform some or all of the operations.

Those skilled in the art will understand that the flow charts described herein illustrates functionality and operations of certain implementations of the present disclosure. In this regard, each block of the flowcharts may represent a module, a segment, or a portion of program code, which includes one or more instructions executable by one or more processors for implementing specific logical functions or steps in the processes. The program code may be stored on any type of computer readable medium, for example, such as a storage device including a disk or hard drive.

In addition, each block may represent circuitry that is wired to perform the specific logical functions in the processes. Alternative implementations are included within the scope of the example implementations of the present application in which functions may be executed out of order from that shown or discussed, including substantially concurrent or in reverse order, depending on the functionality involved, as would be understood by those reasonably skilled in the art. Within examples, any system may cause another system to perform one or more of the operations (or portions of the operations) described below.

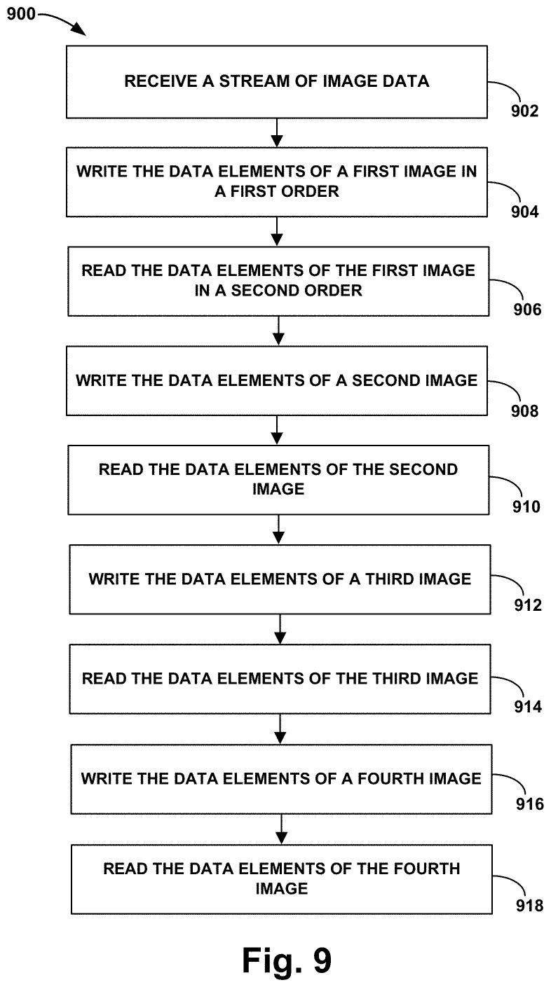

In line with the discussion above, a computing system or an image system (e.g., an image captured device, a camera system 350, remote computing system 302 or server computing system 306) may operate as shown by method 900. At block 902, a memory buffer of the image system may receive a data stream of image data from an image sensor 1000 as shown in FIG. 10. The image sensor 1000 may be configured with a plurality of pixel elements or sensor cells aligned in a plurality of horizontal rows and a plurality of vertical columns. In exemplary embodiments, the image sensor 1000 may have a two-dimensional array 1002 of pixel elements or sensor cells 1004 that may be utilized to capture images. For ease of explanation, the array 1002 of the memory sensor 1000 may be a 3×5 array that may include three rows of pixel elements (N=3) and five columns of pixel elements (M=5) for a total of fifteen pixel elements P₀-P₁₄ as shown in FIG. 10. The image sensor 1000 may be coupled to a processor configured to perform image processing, such as the one or more of the processors described with respect to FIG. 1 or FIG. 3B. The processor may be configured to perform image compression, object recognition, etc.

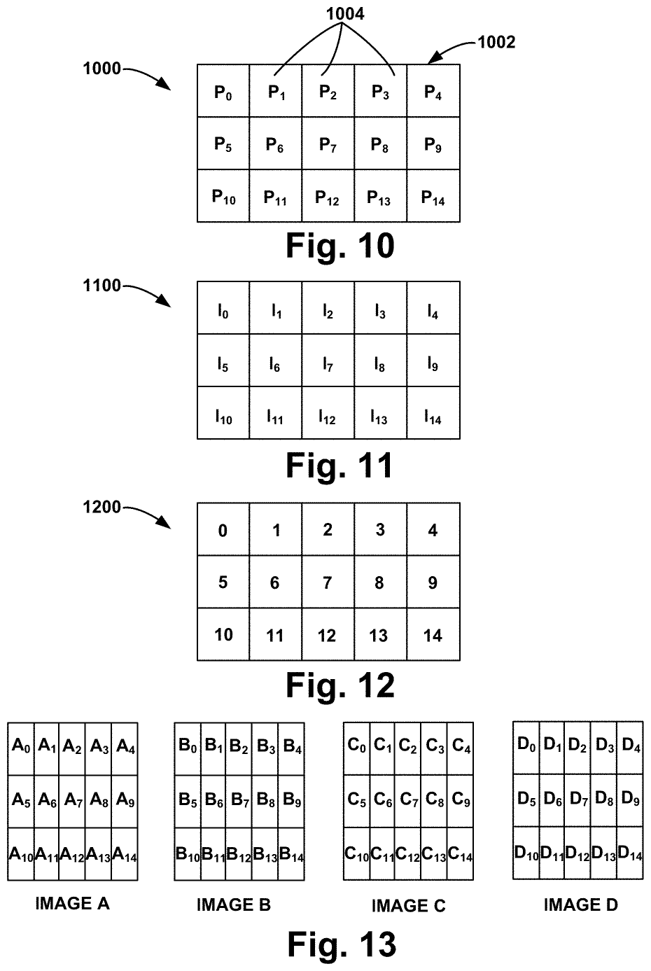

To capture an image, the pixel elements or sensor cells 1004 of the image sensor 1000 may be sampled or scanned to obtain image data (e.g., pixel values). The sampling may be performed across at least one of the horizontal rows of the pixel elements of the image sensor 1000. After each pixel element of a row has been sampled, a new row may be sampled to create another row of image data. The rows may be sampled iteratively until all the rows have been sampled. In one embodiment, the image sensor 1000 may be sampled with a rolling shutter that samples the pixel elements of the image sensor in horizontal rows or vertical columns. The image data or pixels values captured from the image sensor 1000 may be used to form an image or an image frame as represented by the image 1100 shown in FIG. 11. The image 1100 may be a two-dimensional image having a size of three rows of data elements (N=3) and five columns of data elements (M=5) for a total of fifteen data elements I₀-I₁₄.

The data elements of the image 1100 may be organized in a data stream and transmitted to a memory buffer or a storage device, such as the memory buffer 355 of FIG. 3B. The data elements of the image may be arranged in the stream in a row by row format (e.g., consecutive rows). For example, the data stream may begin with the data elements from the first row I₀-I₄, followed by data elements from the second row I₅-I₉, and followed by the data elements of the last row I₁₀-I₁₄.

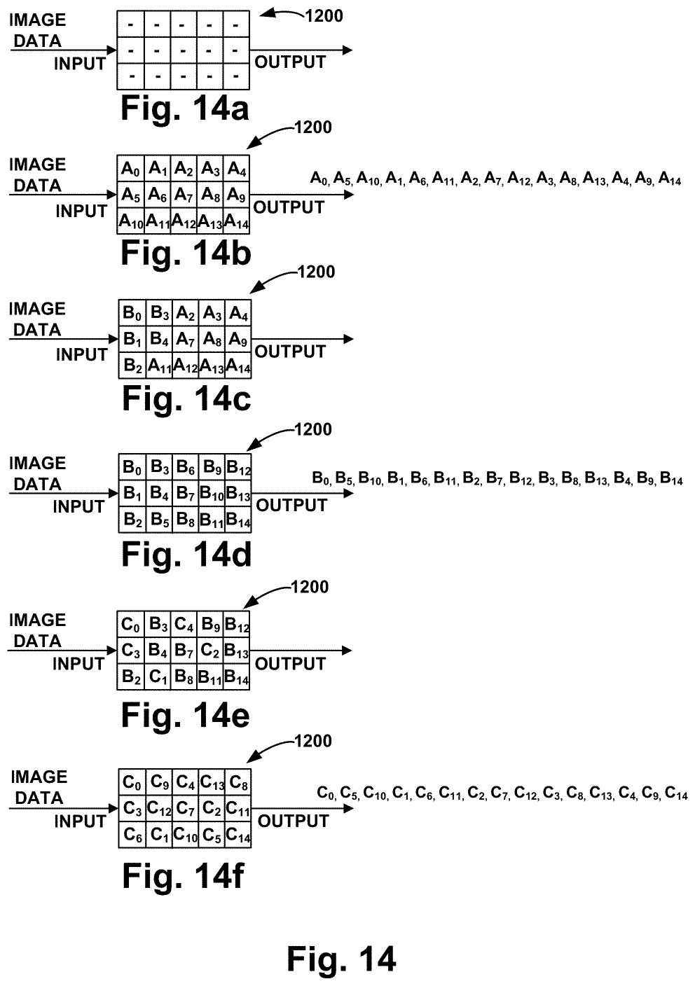

The data elements of the image 1100 may be reordered using a memory array 1200 of a memory buffer as shown in FIG. 12. The memory array 1200 may include fifteen memory cells 0-14 corresponding to the number of the data elements of the image 1100. (For ease of explanation, the size of the memory array and the memory addresses will be indicated in decimal format instead of binary format). In order to access the memory locations or cells in the memory array 1200, addresses may be generated for writing the data elements in the memory array 1200 and reading the data elements from the memory array 1200. For example, a series of addresses may be generated for writing the data elements of the image 1100 in a row-major or row-wise serial order in the memory array 1200. Further, a series of addresses may be generated for reading the data elements of the image 1100 in a column-major or column-wise serial order from the memory array 1200. The addresses may have a range in decimal format from 0 to 14 to access the memory locations or cells of the memory array 1200 as shown in FIG. 12.

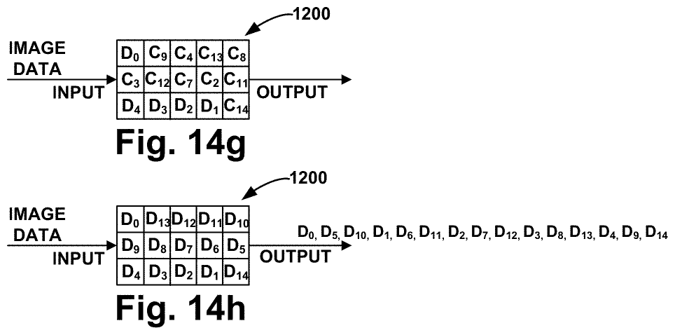

After the memory buffer receives a sequence of images in a data stream, the memory buffer writes the data elements of the image 1100 in the memory array 1200. In this example and for purposes illustration, the reordering of the data elements of successive images in a data stream will be explained in reference to four successive images A, B, C, and D, as shown in FIG. 13. In this example, image A represents a first image captured by the image sensor 1000 during a first time period, image B represents a second image captured by the image sensor 1000 during a second time period, image C represents a third image captured by the image sensor 1000 during a third time period, and image D represents a fourth image captured by the image sensor during a fourth time period. As showing in FIG. 13, each of the images A, B, C, and D have fifteen elements 0-14 and are obtained from an image sensor in a row-major or a row-wise order.

The memory buffer may be configured to receive the data elements of each of the images A, B, C, and D in the data stream. For example, the memory buffer may receive the data stream that begins with the data elements A₀-A₁₄ of image A, followed by the data elements B₀-B₁₄ of image B, followed by the data elements C_{0,}-C₁₄ of image C, and followed by the data elements D₀-D₁₄ of image D. The data elements of each image may be received in a row-major or a row-wise serial order. The data elements of each image may be successively written into the memory array 1200 of the memory buffer in a first order and read from the memory cells of the memory array 1200 in a second, different order.

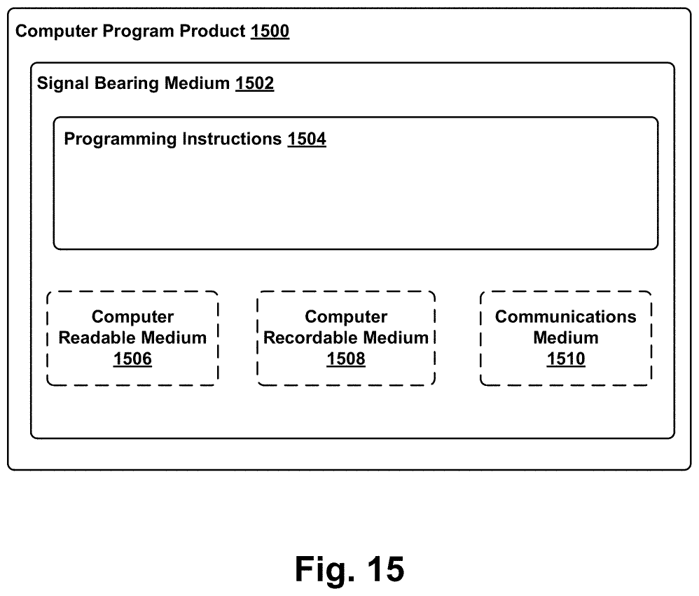

As shown in FIG. 14a, the memory locations of the memory array 1200 may initially be empty or unknown when the memory buffer receives the sequence of images in the data stream. At block 904, the data elements of the first image A_{0,}-A₁₄, are written in a first predetermined order to the memory locations of the memory array 1200. For example, the data elements of the first image A_{0,}-A₁₄, may be written to a series of memory locations in a row-major order according to a sequence of addresses. The addresses may have a range in a decimal format from 0 to 14 to access the memory locations of the memory array 1200. In this example, the data elements of the first image A_{0,}-A₁₄, may be written into the memory locations of the memory array 1200 in a row-major or row-wise serial order as shown in FIG. 14b. As such, the data elements may be written to the memory array 1200 using the series of successive addresses of 0, 1, 2, 3, 4, 5, 6, 7, 8, 9, 10, 11, 12, 13, and 14.

After the data elements of the first image A_{0,}-A₁₄ are stored in the memory array 1200, the data elements of the first image A_{0,}-A₁₄ may be read in a second predetermined order from the memory array at block 906. For example, the data elements of the first image A_{0,}-A₁₄ may be read in a different order than the data elements have been written to the memory array. In exemplary implementations, the data elements of the first image A_{0,}-A₁₄ may be read from the memory locations of the memory array in a column-major or column-wise order.

In order to read the data elements of the first image from the memory array 1200 in a column-wise order, a series or sequence of addresses may be generated for performing the read operations. The sequence of addresses for reading the data elements may be generated based on a determination of the order to serially read the memory locations to obtain the data elements in a column-major order. In this example, the memory locations of the memory array 1200 may be read using the sequence of addresses of 0, 5, 10, 1, 6, 11, 2, 7, 12, 3, 8, 14, 4, 9, and 14 to obtain the data elements of the first image in a column-major serial order of A₀, A₅, A₁₀, A₁, A₆, A₁₁, A₂, A₇, A₁₂, A₃, A₈, A₁₃, A₄, A₉, and A₁₄. As a result, the memory buffer can output the data elements in a data stream in the column-major serial order. Thus, the data elements of the first image A may be reordered from a row-major serial order and organized in an output stream in a column-wise serial order.

After the data elements of the first image are read from the memory array of the memory buffer, the data elements of the second image B_{0,}-B₁₄, of the data stream may be written to the memory array at block 908. For example, the data elements of the second image B_{0,}-B₁₄ may be written to a series of the memory locations in an order that the data elements were received by the memory buffer For example, the data elements B_{0,}-B₁₄ may be written to the memory locations of the memory array 1200 in a row-major order or a row-wise order. The data elements of the second image B_{0,}-B₁₄ may be written to the memory array 1200 according to a series of addresses. In this example, the sequence of addresses used for writing the data elements of the second image may be the same series of addresses used for reading the data elements of the first image A_{0,}-A₁₄ in the memory locations or cells of the memory array 1200. Using the same sequence of addresses for reading the data elements of the first image A_{0,}-A₁₄ from the memory array 1200 and writing the data elements of the second image B_{0,}-B₁₄ to the memory array 1200 may enable the memory buffer to use a single memory array for reordering images to reduce memory capacity and size. Thus, the memory buffer may write the data elements of the second image B_{0,}-B₁₄ to the memory array 1200 according to the previous read addresses sequence of 0, 5, 10, 1, 6, 11, 2, 7, 12, 3, 8, 14, 4, 9, and 14.

FIG. 14c illustrates the data elements of the first row of the second image B_{0,}-B₄, written into the memory locations at addresses 0, 5, 10, 1, and 6. For example, the data element B₀ may be written to the memory location 0, the data elements B₁ may be written to the memory location 5, the data element B₂ may be written to the memory location 10, the data element B₃ may be written to memory location 1, and data element B₄ may be written to memory location 6 as shown in FIG. 14e. As shown in 14d, the remaining data elements of the second image B_{5,}-B₁₄ may be written to the memory locations or cells according to addresses of 11, 2, 7, 12, 3, 8, 14, 4, 9, and 14 to fill the memory array with the data elements of the second image B_{0,}-B₁₄.

Once the data elements of the second image B_{0,}-B₁₄ have been stored in the memory array 1200 of the memory buffer, the data elements of the second image B_{0,}-B₁₄ may be read from the memory locations of the memory array 1200 at block 910. The data elements of the second image B_{0,}-B₁₄ may be read in a different order than the data elements were written in the memory array 1200. For example, the data elements of the second image B_{0,}-B₁₄ may be read in a column-major order or a column-wise order.

In order read the data elements of the second image B_{0,}-B₁₄ from the memory array 1200 in a column-major order, a sequence or series of addresses may be generated for performing the read operations. The addresses for reading the data elements of the second image may be generated based on a determination of the order to read the memory locations to obtain the data elements of the second image in a column-major order. For example, the memory locations of the memory array 1200 may be read using the series of addresses of 0, 11, 8, 5, 2, 13, 10, 7, 4, 1, 12, 9, 6, 3, and 14 to obtain the data elements of the second image in a column-major serial order of B₀, B₅, B₁₀, B₁, B₆, B₁₁, B₂, B₇, B₁₂, B₃, B₈, B₁₃, B₄, B₉, and B₁₄. As a result, the memory buffer can output the data elements of the second image in a data stream in the column-major serial order. Thus, the data elements of the second image may be reordered from a row-major serial order and organized in an output stream in a column-major serial order.

After the data elements of the second image B_{0,}-B₁₄ are read from the memory buffer, the data elements of the third image C₀-C₁₄ of the data stream may be written to the memory locations or cells of the memory array 1200 at block 912. For example, the data elements of the third image C₀-C₁₄ may be written to a series of the memory locations in an order that the data elements were received by the memory buffer. For example, the data elements C₀-C₁₄, may be written to the memory locations of the memory array 1200 in a row-major or row-wise order. The data elements of the third image C₀-C₁₄ may be written to the memory array 1200 according to a series of addresses. In this example, the sequence of addresses used for writing the data elements of the third image C₀-C₁₄ may be the same sequence of addresses used for reading the data elements of the second image B_{0,}-B₁₄ from the memory locations of the memory array 1200. Thus, the memory buffer may write the data elements of the third image C₀-C₁₄ in the memory array 1200 according to the previous read address sequence of 0, 11, 8, 5, 2, 13, 10, 7, 4, 1, 12, 9, 6, 3, and 14.

FIG. 14e illustrates the data elements of the first row of the third image C_{0,}-C₄, written into the memory locations or cells according to the addresses 0, 11, 8, 5 and 2. For example, the data element C₀, may be written to memory location 0, the data element C₁ may be written to the memory location 11, the data element C₂, may be written to the memory location 8, the data element C₃ may be written to the memory location 5, and the data element C₄ may be written to the memory location 2 as shown in FIG. 14e. As shown in 14f, the remaining data elements of the third image C₅-C₁₄, may be written to the memory locations at addresses of 13, 10, 7, 4, 1, 12, 9, 6, 3, and 14 to fill the memory array 1200 with all of the data elements of the third image.

Once the data elements of the third image C₀-C₁₄ have been stored in the memory array 1200, the data elements of the third image C₀-C₁₄ may be read from the memory locations or cells of the memory array 1200 at block 914. The data elements of the third image C₀-C₁₄ may be read in a different order than the data elements were written in the memory locations of the memory array 1200. For example, the data elements of the third image C_{0,}-C₁₄ may be read in a column-major or a column-wise order.

In order read data elements of the third image CO₃-C₁₄ from the memory locations or cells in a column-major order, a sequence or series of addresses may be generated for performing the read operations. The addresses for reading the data elements may be generated based on a determination of the order to read the memory locations to obtain the data elements of the third image in a column-major or column-wise order. For example, the memory locations of the memory buffer may be read using the series of addresses of 0, 13, 12, 11, 10, 9, 8, 7, 6, 5, 4, 3, 2, 1, and 14 to obtain the data elements of the third image in the column-major or column-wise serial order of C₀, C₅, C₁₀, C₁, C₆, C₁₁, C₂, C₇, C₁₂, C₃, C₈, C₁₃, C₄, C₉, and C₁₄. As a result, the memory buffer can output the data elements of the third image in a data stream in a column-major or column-wise serial order. Thus, the data elements of the second image may be reordered from a row-major or row-wise serial order and organized in an output stream in a column-major or column-wise serial order.

After the data elements of the third image C₀-C₁₄ are read from the memory array 1200, the data elements of the fourth image D₁-D₁₄, of the data stream may be written to the memory array 1200 of the memory buffer at block 916. For example, the data elements of the fourth image D₁-D₁₄ may be written to a series of the memory locations of the memory array 1200 in an order received by the memory buffer. For example, the data elements D₀-D₁₄, may be written in the memory locations of the memory array 1200 in a row-major order according to a sequence of addresses. In this example, the sequence of addresses for writing the data elements of the fourth image D₀-D₁₄ may be the same sequence of addresses used for reading the data elements of the third image C_{0,}-C₁₄ from the memory locations of the memory array 1200. Thus, the memory buffer may write the data elements of the forth image D_{0,}-D₁₄ according to the previous read address sequence of 0, 13, 12, 11, 10, 9, 8, 7, 6, 5, 4, 3, 2, 1, and 14.

FIG. 14g illustrates the data elements of the first row of the fourth image D_{0,}-D₄, written into the memory location or cells according to the addresses 0, 13, 12, 11 and 10. For example, the data element D₀ may be written to the memory location 0, the data element D₁ may be written to the memory location 13, the data element D₂ may be written to the memory location 12, the data element D₃ may be written to the memory location 11, and the data element D₄ may be written to the memory location 13 as shown in FIG. 14g. As shown in 14h, the remaining data elements of the fourth image D₅-D₁₄, may be written to the memory array 1200 at the addresses of 13, 10, 7, 4, 1, 12, 9, 6, 3, and 14 to fill the memory location or cells of the memory array 1200 with the data elements of the fourth image D₀-D₁₄.

Once the data elements of the fourth image D₀-D₁₄ have been stored in the memory array 1200, the data elements of the fourth image D₀-D₁₄ may be read from the memory locations of the memory array 1200 at block 918. The data elements of the fourth image D₀-D₁₄ may be read in a different order than the data elements were written to the memory array 1200. For example, the data elements of the fourth image D₀-D₁₄ may be read in a column-major order or a column-wise order.

In order to read the data elements of the fourth image D₀-D₁₄ from the memory array 1200 in a column-wise order, a sequence of addresses may be generated for performing the read operations. The addresses for reading the data elements may be generated based on a determination of the order to read the memory locations of the memory array 1200 to obtain the data elements of the fourth image in a column-major order. For example, the memory locations of the memory array 1200 may be read using the sequence of addresses of 0, 9, 4, 13, 8, 3, 12, 7, 2, 11, 6, 2, 10, 1, 14 to obtain the data elements of the fourth image in the column-major serial order of D₀, D₅, D₁₀, D₁, D₆, D₁₁, D₂, D₇, D₁₂, D₃, D₈, D₁₃, D₄, D₉, and D₁₄. As a result, the memory buffer can output the data elements of the fourth image in a data stream in the column-major serial order. Thus, the data elements of the fourth image may be reordered from a row-major serial order and the organized in at data stream in a column-wise serial order. The process described above may be used to reorder other images in the input stream or other input streams.

FIG. 15 is a schematic diagram of a computer program, according to an example implementation. In some implementations, the disclosed methods may be implemented as computer program instructions encoded on a non-transitory computer-readable storage media in a machine-readable format, or on other non-transitory media or articles of manufacture.

In an example implementation, computer program product 1500 is provided using signal bearing medium 1502, which may include one or more programming instructions 1504 that, when executed by one or more processors may provide functionality or portions of the functionality described above with respect to FIGS. 1-3 and 8. In some examples, the signal bearing medium 1502 may encompass a non-transitory computer-readable medium 1506, such as, but not limited to, a hard disk drive, a CD, a DVD, a digital tape, memory, components to store remotely (e.g., on the cloud) etc. In some implementations, the signal bearing medium 1502 may encompass a computer recordable medium 908, such as, but not limited to, memory, read/write (R/W) CDs, R/W DVDs, etc. In some implementations, the signal bearing medium 1502 may encompass a communications medium 1510, such as, but not limited to, a digital and/or an analog communication medium (e.g., a fiber optic cable, a waveguide, a wired communications link, a wireless communication link, etc.). Similarly, the signal bearing medium 1502 may correspond to a remote storage (e.g., a cloud). A computing system may share information with the cloud, including sending or receiving information. For example, the computing system may receive additional information from the cloud to augment information obtained from sensors or another entity. Thus, for example, the signal bearing medium 1502 may be conveyed by a wireless form of the communications medium 1510.

The one or more programming instructions 904 may be, for example, computer executable and/or logic implemented instructions. In some examples, a computing device such as the computer system 112 of FIG. 1 or remote computing system 302 and perhaps server computing system 306 of FIG. 3A or one of the processor of FIG. 3B may be configured to provide various operations, functions, or actions in response to the programming instructions 904 conveyed to the computer system 112 by one or more of the computer readable medium 1506, the computer recordable medium 908, and/or the communications medium 1510.

The non-transitory computer readable medium could also be distributed among multiple data storage elements and/or cloud (e.g., remotely), which could be remotely located from each other. The computing device that executes some or all of the stored instructions could be a vehicle, such as vehicle 200 illustrated in FIG. 2. Alternatively, the computing device that executes some or all of the stored instructions could be another computing device, such as a server.

The above detailed description describes various features and operations of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. An apparatus for rearranging image data of a stream comprising:
a memory array;
control circuitry coupled to the memory array, the control circuitry configured to:
receive the image data of the stream, the image data including a first image comprising first data elements organized in a row-wise format or a column-wise format and a second image comprising second data elements organized in a row-wise format or a column-wise format;
write the first data elements to the memory array in a first order according to a first addressing sequence;
read the first data elements from the memory array in a second order according to a second addressing sequence; and
write the second data elements in the memory array according to the second addressing sequence.

2. The apparatus of claim 1, where the stream includes a sequence of images, wherein the first image and the second image comprise sequential images in the stream, wherein the first order comprises a row-major order, wherein the second order comprises a column-major order, and wherein the second addressing sequence is different from the first addressing sequence.

3. The apparatus of claim 1, wherein the first data elements are received in row-major order, and wherein the second data elements are received in row-major order.

4. The apparatus of claim 1, wherein the second data elements are written to a series of memory locations in a row-major order, where at least two memory locations of the series of memory locations are non-successive memory locations.

5. The apparatus of claim 1, wherein the control circuitry is further configured to read the second data elements from the memory array according to a third addressing sequence.

6. The apparatus of claim 1, wherein the control circuitry is further configured to output the first data elements in a column-major order.

7. The apparatus of claim 1, wherein the first data elements are sequentially read from a series of memory locations.

8. The apparatus of claim 1, wherein the second data elements are written to a first series of memory locations in an order that the first data elements are read from the first series of the memory locations.

9. The apparatus of claim 1, wherein the control circuitry is further configured to determine the second address sequence based on a series of memory locations storing the first data elements in a column-major order.

10. The apparatus of claim 1, further comprising an image capture device configured to capture the first data elements and the second data elements in a row-by-row format, wherein the first data elements being representative of pixel values of the first image and the second data elements being representative of pixel values of the second image.

11. The apparatus of claim 1, wherein the control circuitry is further configured to:
read the second data elements from the memory array according to a third addressing sequence;
write third data elements of a third image in the memory locations in a row-major order using the third addressing sequence; and
read the third data elements in a column-major order from the memory array using a fourth addressing sequence.

12. The apparatus of claim 1, further comprising an optical system configured to receive light at an image sensor, wherein the image sensor comprises a plurality of pixel elements aligned in a plurality of horizontal rows and a plurality of vertical columns.

13. The apparatus of claim 12, wherein the control circuitry is further configured to obtain image data from the image sensor by sampling one or more pixel elements of the image sensor.

14. The apparatus of claim 1, further comprising a vehicle, wherein the vehicle includes the memory array and the control circuitry.

15. A method of rearranging image data in a stream, the method comprising:
receiving, at a memory, the image data of the stream, the image data including a first image comprising first data elements organized in a row-wise format or a column-wise format and a second image comprising second data elements organized in a row-wise format or a column-wise format;
writing the first data elements in memory locations of the memory in a first order using a first addressing sequence;
reading the first data elements from the memory locations in a second order using a second addressing sequence; and
writing the second data elements in the memory locations using the second addressing sequence.

16. The method of claim 15, where the stream includes a sequence of images, wherein the first image and the second image comprise sequential images in the stream, wherein the first order comprises a row-major order, wherein the second order comprises a column-major order, wherein the second addressing sequence is different from the first addressing sequence, and wherein the first data elements are sequentially read from a first series of the memory locations of the memory.

17. The method of claim 15, further comprising outputting the first data elements in a column-major order, wherein the first data elements are received in a row-major order, and wherein the second data elements are received in row-major order.

18. The method of claim 15, further comprising writing the second data elements in a first series of the memory locations in an order that the first data elements were read from the memory locations.

19. The method of claim 15, further comprising:
reading the second data elements from the memory array in a column-major order according to a third addressing sequence;
writing third data elements of a third image in the memory locations using the third addressing sequence; and
reading the third data elements in a column-major order from the memory location using a fourth addressing sequence.

20. A non-transitory computer-readable medium storing instructions, the instructions being executable by one or more processors to perform functions comprising:
receiving image data of a stream, the image data including a first image comprising first data elements organized in a row-wise format or a column-wise format and a second image comprising second data elements organized in a row-wise format or a column-wise format;
writing the first data elements in memory locations of a memory in a first order using a first addressing sequence;
reading the first data elements from the memory locations in a second order using a second addressing sequence; and
writing the second data elements in the memory locations using the second addressing sequence.
